(19) United States
(12) Patent Application Publication
(10) Pub. No.: US 2005/0010450 A1
(43) Pub. Date: Jan. 13, 2005

(54) Method and apparatus for utilizing electronic models of patient teeth in interdisciplinary dental treatment plans

(75) Inventors: Bruce Willard Hultgren, Victoria, MN (US); Michael C. Marshall, Savage, MN (US); Robert J. Isaacson, Edina, MN (US); Jamie Ledin, Chanhassen, MN (US)

Correspondence Address: MERCHANT & GOULD PC, P.O. BOX 2903, MINNEAPOLIS, MN, 55402-0903, US

(73) Assignee: GEODIGM CORPORATION, CHANHASSEN, MN (US)

(21) Appl. No.: 10/840,697

(22) Filed: May 5, 2004

Related U.S. Application Data
(60) Provisional application No. 60/467,960, filed on May 5, 2003.

(51) Int. Cl. G06F 17/60

(52) U.S. Cl. 705/3; 705/7

(57) ABSTRACT

A method, apparatus, and article of manufacture is disclosed for providing a dental treatment plans using electronic models, and more particularly to a method, apparatus, and article of manufacture for utilizing electronic models of patient teeth in interdisciplinary dental treatment plans. The system and method permit the electronic generation and specification of electronic models and then dental treatment plans for patients that require interdisciplinary treatment that may include orthodontic treatment, may include the generation of crown, bridge, and implant dental appliances that may be specified in an industry standard file specification. This specification is utilized in a rapid prototyping process to generate a wax impression for the appliance that may then be fabricated using standard lost-wax fabrication techniques.

### CROSS REFERENCE TO RELATED APPLICATIONS

This application claims benefit of provisional application Ser. No. 60/467,960, filed on May 5, 2003, which application is incorporated herein by reference.

### TECHNICAL FIELD

This application relates in general to a method, apparatus, and article of manufacture for providing a dental treatment plans using electronic models, and more particularly to a method, apparatus, and article of manufacture for utilizing electronic models of patient teeth in interdisciplinary dental treatment plans.

### BACKGROUND

With the development of computing systems, graphics and display systems, computer-aided design software packages, 3-dimensional scanning systems and computer-controlled, rapid prototyping technologies, an ability to design and then fabricate custom components, devices and appliances has begun to become feasible. While these individual technologies have been developing for some time, the ability to provide opportunities to use these technologies in a wide number of industries has been limited by the ability to provided useable systems at reasonable costs. In some industries, the alternative to using computer-aided systems are labor intensive methodologies that require highly trained and skilled workers capable of designing and fabricating custom components. These industries are in need of computer-aided systems to allow more efficient design and fabrication of one-of-a-kind components.

One such industry is the dental care field. Dental care is currently provided by professionals and highly skilled technicians who fabricate crown, bridge, and implant appliances, orthodontic appliances, and related devices as one-of-a-kind components that are typically manufactured by hand to fit the size and dental requirements of each individual patient. Typically, a plaster model of the patient's mouth and teeth is created from an impression taken by a dental professional. This model is then used to customize and fabricate the appliances and related devices that are needed to provide the dental care. This design and fabrication process is typically expensive and time-consuming as each component is made by hand by trained dental technicians who follow the instructions of dental professionals.

The above-mentioned development in computing technology has begun to reach the dental care industry. New computer-related technologies are beginning to be developed to address various steps in the component design and fabrication processing. An example of such a system is described in U.S. Pat. No. 6,217,334 which discloses a system and method for scanning negative image scan data related to dental impressions. Also, U.S. patent application Ser. No. 10/350,302 discloses a system and method to generate electronic models for dental impressions. In addition, U.S. patent application Ser. No. 09/846,037 discloses a system and method for scanning and remote delivery of electronic models for dental impressions.

The electronic models can be utilized to perform various dental care treatment functions that are needed as part of providing treatment to dental patients, as disclosed in U.S. patent application Ser. No. 10/350,304; U.S. patent application Ser. No. 10/426,252; U.S. patent application Ser. No. 10/426,253; U.S. patent application Ser. No. 10/429,262; U.S. patent application Ser. No. 10/349,559; U.S. patent application Ser. No. 10/429,288.

All of the above applications are commonly assigned with the instant application and are incorporated by reference herein. These prior systems generated the electronic models to permit dentists to use the models in place of the physical models. The prior systems permit the manipulation of teeth within the model as part of designing a treatment plan for a patient.

These earlier systems, however, do not provide dental care providers with the ability to perform complete treatment plan assessment, education and planning. The present invention addresses the above limitations of prior dental electronic modeling systems.

### SUMMARY

In accordance with the present invention, the above and other problems are solved by providing a method, apparatus, and article of manufacture for utilizing electronic models of patient teeth in interdisciplinary dental treatment plans. The great utility of the invention is that the system and method permit the electronic generation and specification of crown, bridge, and implant dental appliances, orthodontic devices and related dental care components that may be specified in an industry standard file specification. This specification is utilized in a rapid prototyping process to generate a wax impression for the appliance that may then be fabricated using standard lost-wax fabrication techniques.

These and various other features as well as advantages, which characterize the present invention, will be apparent from a reading of the following detailed description and a review of the associated drawings.

### BRIEF DESCRIPTION OF THE DRAWINGS

Referring now to the drawings in which like reference numbers represent corresponding parts throughout:

FIG. 1 illustrates an example of a computing system constructed according to one embodiment of the present invention.

FIG. 2 illustrates a general purpose computing system for use in implementing one or more computing embodiments of the present invention.

FIG. 3 illustrates an electronic model of a dental impression having a prep site for insertion of a crown according to an example embodiment of the present invention.

FIG. 4 illustrates various views of a patient and her teeth for use with a system according to one embodiment of the present invention.

FIG. 5 illustrates an electronic version of an x-ray with teeth and other anatomical measurements annotated in accordance with an embodiment of the present invention.

FIG. 6 illustrates an electronic model of a dental impression in accordance with another embodiment of the present invention.

FIG. 7 illustrates an electronic model of an upper dental arch constructed according to an embodiment of the present invention.

FIG. 8 illustrates an electronic model of an orthodontic treatment plan constructed according to an embodiment of the present invention.

FIG. 9 illustrates an electronic model of a lateral incisor space that is part of an orthodontic treatment plan constructed according to an embodiment of the present invention.

FIG. 10 illustrates an electronic model of an oral surgeon treatment plan constructed according to an embodiment of the present invention.

FIG. 11 illustrates an electronic model of a lateral incisor space that is part of an oral surgeon treatment plan constructed according to an embodiment of the present invention.

FIG. 12 illustrates an electronic model of an upper dental arch having a customized arch form constructed according to an embodiment of the present invention.

FIG. 13 illustrates an electronic model of an upper dental arch used to determine an amount of space available for a treatment plan according to an embodiment of the present invention.

FIG. 14 illustrates an electronic model of an upper dental arch used to determine an amount of space needed for a treatment plan according to an embodiment of the present invention.

FIG. 15 illustrates an electronic model of a general dentist treatment plan constructed according to an embodiment of the present invention.

FIG. 16 illustrates an electronic model of a patient's teeth having tooth sculpting according to an embodiment of the present invention.

FIG. 17 illustrates an electronic model of a patient's teeth having a canine tooth sculpted according to an embodiment of the present invention.

FIG. 18 illustrates a cross-section view from an electronic model of an patient's teeth having a canine tooth sculpted according to an embodiment of the present invention.

FIG. 19 illustrates a set of electronic models of a patient's teeth for various treatment options according to an embodiment of the present invention.

FIG. 20 illustrates another set of electronic models of a patient's teeth for various treatment options according to an embodiment of the present invention.

FIG. 21 illustrates a set of processing modules comprising a client computing system for dentists, oral surgeons, and other health care providers according to an embodiment of the present invention.

FIG. 22 illustrates a set of processing modules comprising a client computing system for patients and insurance payment personnel according to an embodiment of the present invention.

FIG. 23 illustrates a set of processing modules comprising a server computing system according to an embodiment of the present invention.

FIG. 24 illustrates a flowchart for a process of creating a treatment plan for a patient using multiple dental health care providers according an embodiment of the present invention.

### DETAILED DESCRIPTION

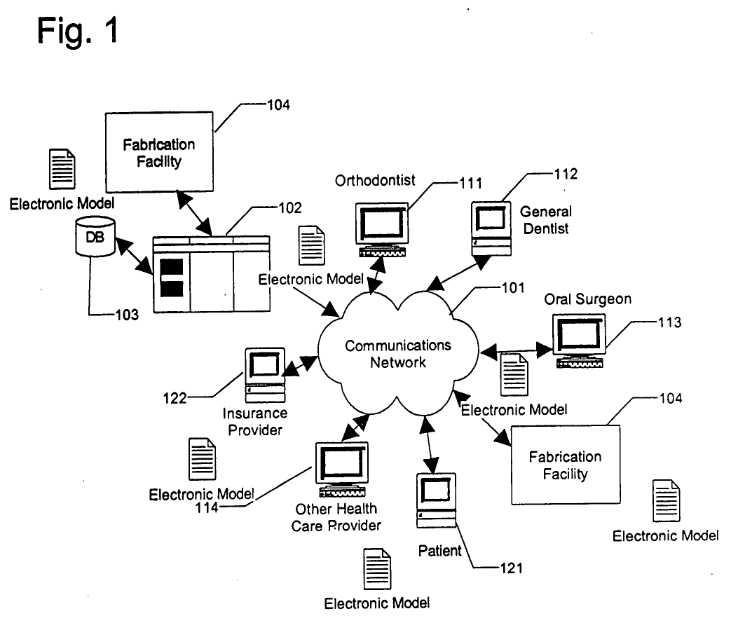

A method, apparatus, and article of manufacture for providing dental treatment plans using electronic models, and more particularly to a method, apparatus, and article of manufacture for utilizing electronic models of patient teeth in interdisciplinary dental treatment plans is disclosed. FIG. 1 illustrates an example of a computing system constructed according to one embodiment of the present invention. A distributed processing system is utilized between dental health care providers 111-114, dental device fabrication facilities 104, patients 121, and health insurance providers 122 to develop and implement a treatment plan for an individual patient. Central to the present invention is use of an electronic model corresponding to an impression of a patient's teeth.

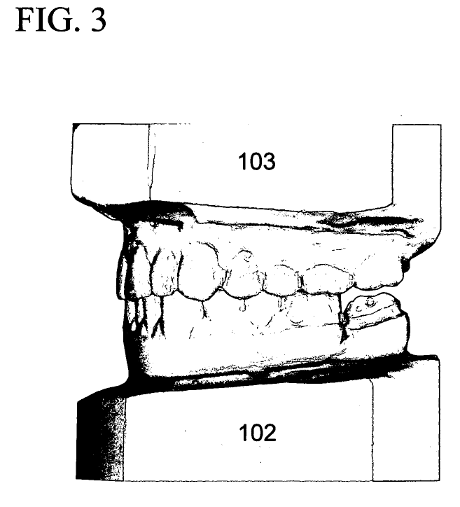

As is typically done to develop treatment plans for patients, a dental health care provider takes an impression of a patient's teeth; a plaster model is then made that represents the state of the teeth in the patient's mouth. This physical model is then scanned to create an electronic representation of the impression as is shown in FIG. 3. This process may be repeated at various times during the implementation of a treatment plan as the state of the patient's teeth change as a result of treatment. The scanning process typically is performed at a remote fabrication facility 104 and the electronic models are stored on a server 102 within a database 103. Once stored in the database, the models are available to any and all other users via a suitable communications network 101. Additional details regarding the creation of the electronic models may be found within U.S. patent application Ser. No. 10/350,302.

The electronic model is stored as a digital representation of the physical model. The electronic model represents the surface of the model as a polygonal mesh. The mesh is described as a set of polygons, typically triangles, having vertices at particular locations in space. For fabrication of components, these meshes may be represented using an industry standard STL file. For internal use within the system, a more compact digital form for this file may be used. Additionally, header information that includes annotations and other information may be included. This digital file format may be easily translated to an STL format when interacting with fabrication systems. The files, both digital representation and STL provide a definition for all polygons and corresponding vertices that are used to define the mesh.

The electronic model is shared between the various dental health care providers 111-114 to develop and implement a treatment plan for the patient. As part of this process, each dental health care provider 111-114 may propose a course of treatment using the electronic model. Because the treatment plan being proposed is generated digitally, the electronic model is used to construct the expected results from the treatment being proposed. As is discussed in various of the above referenced and commonly assigned patent applications, the individual teeth within the model may be located and moved as desired. Locations for orthodontic brackets may be determined and utilized. This information may then be used to create trays to insert orthodontic brackets into a patient's mouth to implement a treatment plan.

Additionally, the electronic models may be used to define and construct crown, bridge and implants that when fabricated may be inserted into a patient's mouth. FIG. 3 illustrates an electronic model of upper 301 and lower 302 arches for a patient where a prep site for such a dental appliance may be inserted. Typically, the above described orthodontic treatment plans are developed by one professional, an orthodontist, and the crown based treatment plan is developed by a general dentist. Oral surgeons may also develop a separate, or compatible portion of a treatment plan using these tools.

In the past, these separate plans were created by each professional independent of the work of the other. Coordination between the professionals has been difficult as physical models are not easily passed between professionals. In addition, patients and dental health care providers have experienced difficulty in comparing the possible outcomes of various treatment options. Using electronic models to easily pass proposed treatment plans between providers allows coordination between the care recommended and provided to patients. Finally, the electronic models provide a mechanism to illustrate the expected results from moving, removing, realigning and fixing teeth. As a result, both patients and dental health care providers may see realistic expected results from a course of treatment prior to its initiation to determine whether the results justify the expense and effort needed.

When this process occurs, a dental care professional 111-114 retrieves an electronic model from a database 103 on a central server 102 for modification on a client computer. The modifications represent the results for a course of treatment and may include removal, movement, and restoration of one or more teeth. The modifications are made within the electronic model data file. The dental health care provider may include annotations and notes into this electronic model file for retrieval and use by subsequent dental health care providers. The modified electronic model file is then stored back into the database 103 for later use by the same or other dental health care providers. A standard version control system for identifying each variation of an electronic model may be included within the server 102 and database 103.

The electronic models, with annotations, may also be retrieved by a patient in order for a patient and his or her family to view the model and the doctor's annotations as part of the decision and education process regarding the course of treatment recommended. These models and annotations may also be useful to insurance providers who are deciding if a particular course of treatment is needed.

While the above description of a system assumes that (a) a central server is used to store the electronic models and (b) a client computer is sufficient to manipulate the electronic models as needed, one skilled in the art will recognize that other computing options are available. For example, the electronic models may be stored locally on the systems of the individual dental health care providers and transmitted as individual files between the doctor and other health care providers, patients and insurance providers using file transfer mechanism and/or electronic mail. Additionally, a system may also be constructed in which a user connects to a larger server 102 using a terminal server process such as the TERMINAL SERVER APPLICATION from MICROSOFT CORPORATION that is part of WINDOWS XP PRO, the REMOTE ACCESS APPLICATION from APPLE COMPUTER, and METAFRAME SERVER APPLICATION available from CITRIX SYSTEMS. In these computing environments, a remote client logs into a server system and all of the processing is performed on the server. The resultant window image to be displayed to a user is generated by the server application and transmitted over a communications network to a client computer. In such a system, the computational capabilities of the client computer are minimized and terminal applications run by client computers may be developed in any number of operating systems while the electronic model processing system may be run on its own system. Finally, 2-dimensional images taken from a display of an electronic model may be presented to patients and insurance providers, along with the annotations data, using a web browser if full manipulation of the electronic models is not needed.

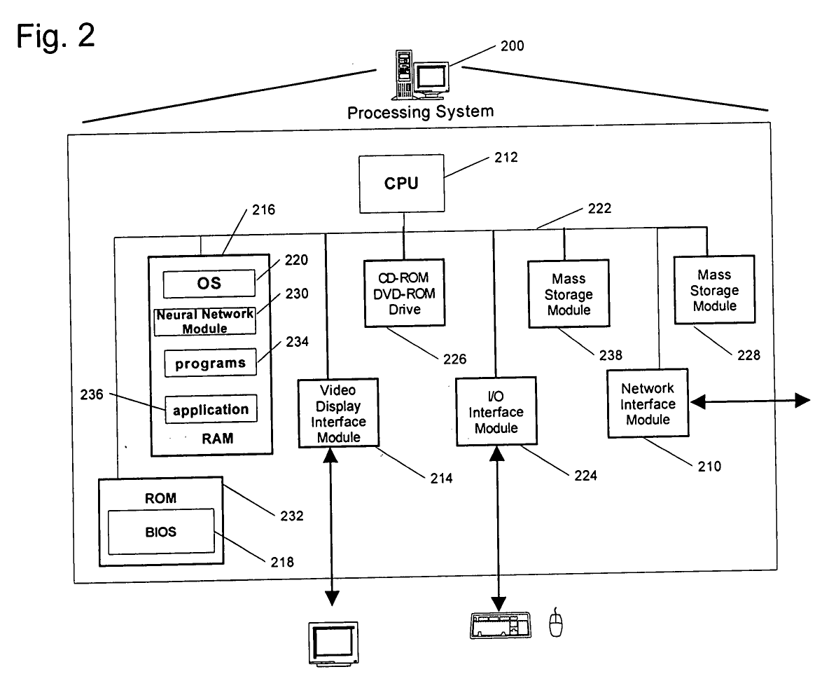

With reference to FIG. 2, an exemplary system for implementing the invention includes a general-purpose computing device in the form of a conventional personal computer 200, including a processor unit 212, a system memory 216, and a system bus 222 that couples various system components including the system memory 216 to the processor unit 212. The system bus 222 may be any of several types of bus structures including a memory bus or memory controller, a peripheral bus and a local bus using any of a variety of bus architectures. The system memory includes read only memory (ROM) 232 and random access memory (RAM) 216. A basic input/output system 218 (BIOS), which contains basic routines that help transfer information between elements within the personal computer 200, is stored in ROM 232.

The personal computer 200 further includes a hard disk drive 238 for reading from and writing to a hard disk, a magnetic disk drive for reading from or writing to a removable magnetic disk, and an optical disk drive 226 for reading from or writing to a removable optical disk such as a CD ROM, DVD, or other optical media. The hard disk drive 238, magnetic disk drive, and optical disk drive 226 are connected to the system bus 222 by a hard disk drive interface, a magnetic disk drive interface, and an optical drive interface, respectively. The drives and their associated computer-readable media provide nonvolatile storage of computer readable instructions, data structures, programs, and other data for the personal computer 200.

Although the exemplary environment described herein employs a hard disk 238, a removable magnetic disk, and a removable optical disk 226, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk 238, magnetic disk, optical disk 226, ROM 232 or RAM 216, including an operating system 220, one or more application programs 230, other program modules 234, and program data 236. A user may enter commands and information into the personal computer 200 through input devices such as a keyboard and mouse or other pointing device. Examples of other input devices may include a microphone, joystick, game pad, satellite dish, and scanner. These and other input devices are often connected to the processing unit 212 through a I/O port interface 224 that is coupled to the system bus 222. Nevertheless, these input devices also may be connected by other interfaces, such as a parallel port, game port, or a universal serial bus (USB). A monitor or other type of display device is also connected to the system bus 222 via an interface, such as a video adapter 214. In addition to the monitor, personal computers typically include other peripheral output devices (not shown), such as speakers and printers.

The personal computer 200 may operate in a networked environment using logical connections to one or more remote computers, such as a remote computer. The remote computer may be another personal computer, a server, a router, a network PC, a peer device or other common network node, and typically includes many or all of the elements described above relative to the personal computer 200. The network connections include a local area network (LAN) and a wide area network (WAN). Such networking environments are commonplace in offices, enterprise-wide computer networks, intranets, and the Internet.

When used in a LAN networking environment, the personal computer 200 is connected to the local network through a network interface or adapter 210. When used in a WAN networking environment, the personal computer 200 typically includes a modem or other means for establishing communications over the wide area network, such as the Internet. The modem, which may be internal or external, is connected to the system bus 222 via the I/O port interface 224. In a networked environment, program modules depicted relative to the personal computer 200, or portions thereof, may be stored in the remote memory storage device. It will be appreciated that the network connections shown are exemplary, and other means of establishing a communications link between the computers may be used.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

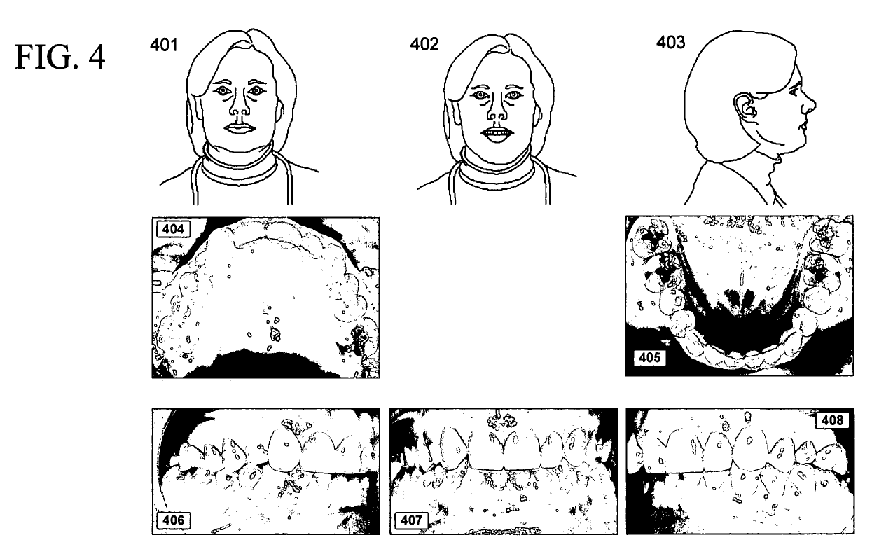

FIG. 4 illustrates various views of a patient 401-403 and her teeth 404-408 for use with a system according to one embodiment of the present invention. This set of images is typically used as part of the development of a treatment plan in which a patient and her teeth are shown. Electronic models illustrate the same information, both before and after treatment, as a dental professional proposes a course of treatment. Using standard digital graphic programming techniques, results of a proposed treatment plan, shown in the form of a modified electronic model, may be superimposed upon these photographs to illustrate to the patient the likely results from a particular course of treatment. This approach may allow dental professionals to create reasonable expectations within the patients regarding the final results to be expected as well as the amount of work that will need to be performed. In addition, typical graphics processing techniques to add shading, reflectivity, color, and similar additions of realistic renderings for teeth may be included in this processing to provide the most realistic image for the treatment plan. In addition to educating a patient on the expected results from one proposed course of treatment, several dental professionals may propose treatment plans to move teeth, create restorations, or some combination where a patient is then presented with the expected results from each treatment plan to be used by all involved to select a desired course of treatment for the patient.

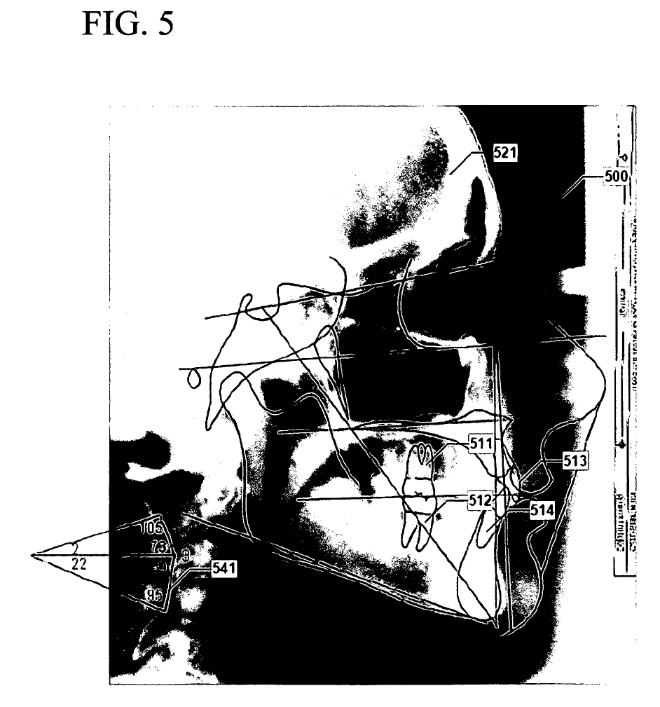

FIG. 5 illustrates an electronic version of an x-ray with teeth and other anatomical measurements annotated in accordance with an embodiment of the present invention. Additional digital data from patients may be considered and used by various dental professionals in developing their respective treatment plans. The x-ray data 500 shows various teeth positions 511-514 relative to the patient's skull 521 and measurements 541 of interest may be obtained. This information may be used when working with an electronic model.

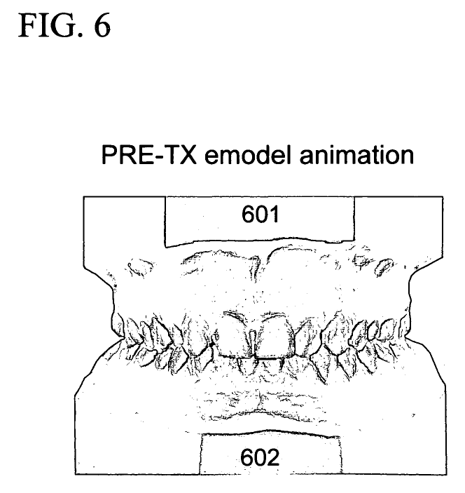

FIG. 6 illustrates an electronic model of a dental impression in accordance with another embodiment of the present invention. All treatment plans begin with the generation of the initial electronic model. This model consists of a polygonal mesh for the upper 601 and the lower 602 arch for an impression of a patient's teeth. As discussed above, a dental health care provider takes an impression of a patient's teeth; a plaster model is then made that represents the state of the teeth in the patient's mouth. This physical model is then scanned to create an electronic representation of the impression as is shown in FIG. 6. This process may be repeated at various times during the implementation of a treatment plan as the state of the patient's teeth change as a result of treatment. The scanning process typically is performed at a remote fabrication facility 104 and the electronic models are stored on a server 102 within a database 103. Once stored in the database, the models are available to any and all other users. FIG. 6 illustrates a pre-treatment impression that may be used by several dental professionals to prepare treatment plans for consideration.

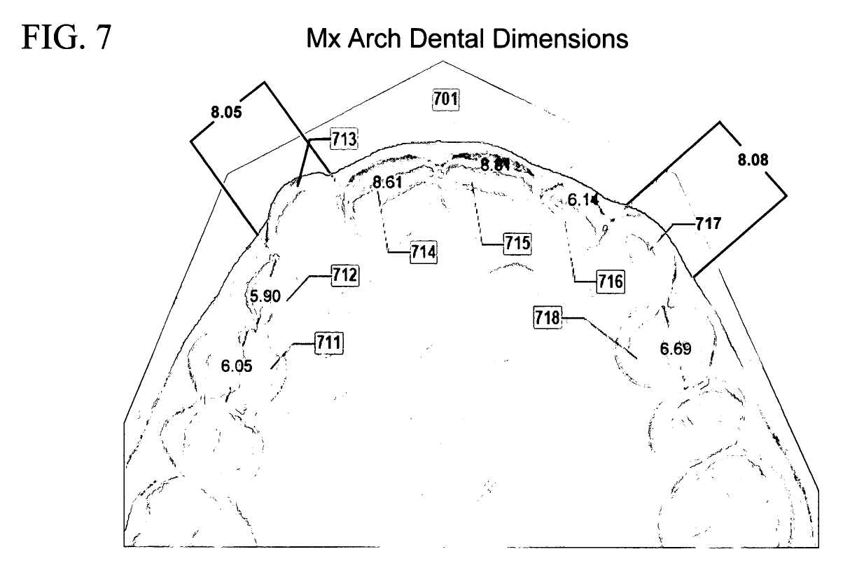

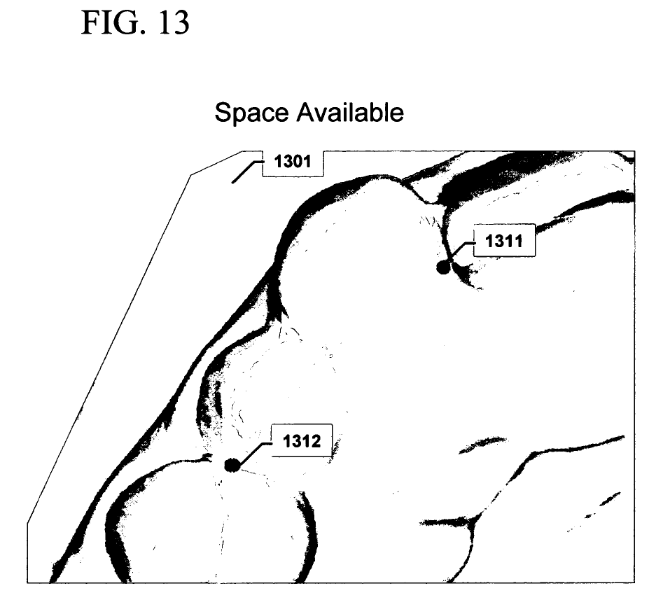

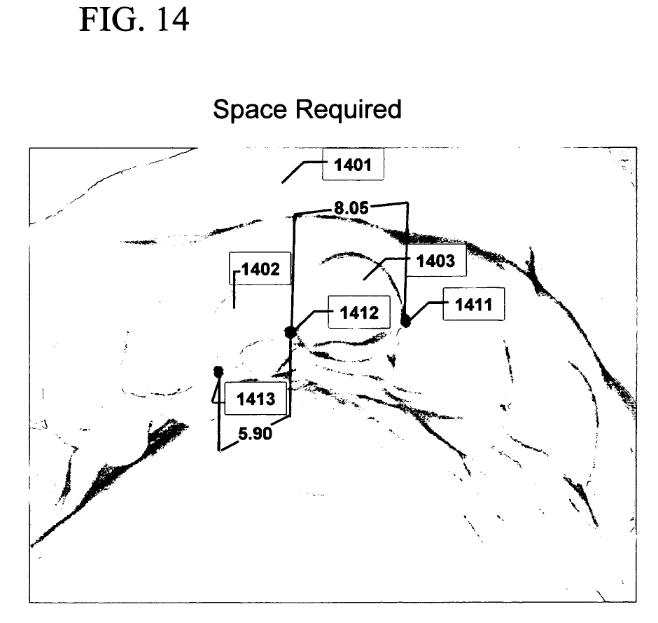

FIG. 7 illustrates an electronic model of an upper dental arch constructed according to an embodiment of the present invention. In this example, an upper arch 701 is shown. The location and size of various teeth 711-718 are illustrated. Because the electronic model is a digital representation of the patient's impression, measurements for the size and location of teeth may be directly obtained. This information may be used in the development of treatment plans. For example, FIG. 13 illustrates measurements for space available in an upper arch 1301 between two points 1311-1312, while FIG. 14 illustrates measurements for space needed in an upper arch 1401 for two teeth 1402-1403 based on three measurement points 1411-1413, for a particular treatment plan being proposed by a dental professional. These measurements and options may be repeated for as many proposed treatment plans developed by one or more dental professionals.

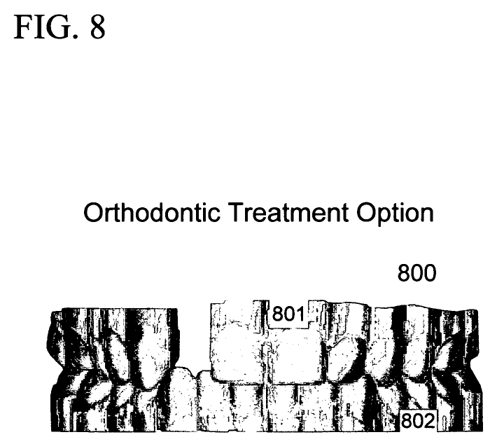

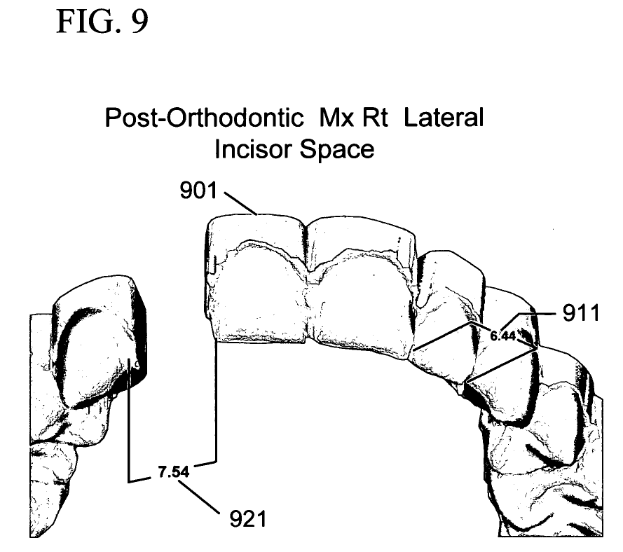

FIG. 8 illustrates an electronic model of upper 801 and lower 802 arches for an orthodontic treatment plan 800 constructed according to an embodiment of the present invention. FIG. 9 illustrates a related electronic model of a lateral incisor space that is part of an orthodontic treatment plan constructed according to an embodiment of the present invention. These two models, or views of a proposed treatment plan, show the possible orthodontic treatment plan option that removes and moves teeth to address the needs of the patient beginning with the impression shown in FIG. 6. FIG. 8 shows an arrangement of teeth according to the proposed plan. FIG. 9 shows various spatial measurements 911, 921 for teeth in an upper arch 901 according to the plan.

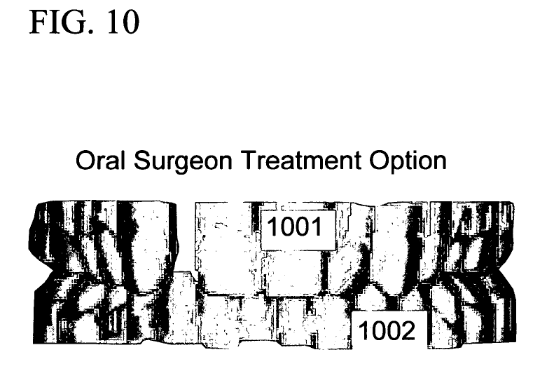

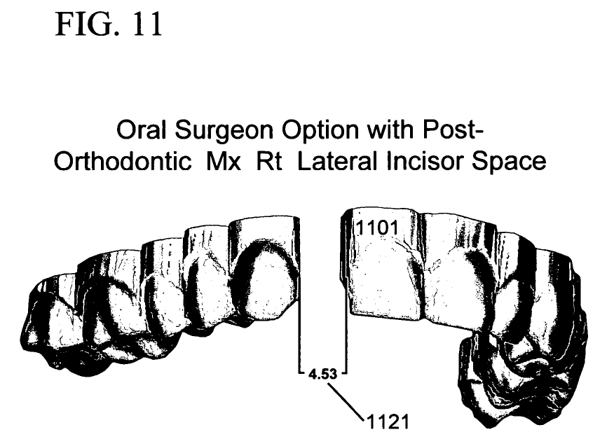

FIG. 10 illustrates an electronic model of upper 1001 and lower 1002 arches for an oral surgeon treatment plan constructed according to an embodiment of the present invention. FIG. 11 illustrates an electronic model 1101 of a lateral incisor space that is part of an oral surgeon treatment plan constructed according to an embodiment of the present invention. This treatment option is separate from the prior proposed treatment plan. The treatment plan in FIGS. 10 and 11 utilizes the use of an oral surgeon and orthodontist in which an oral surgeon performs corrective treatment in combination with the orthodontic treatment. Once again, FIG. 11 illustrates a measurement of a lateral incisor space 1121 expected as part of this treatment plan. These results may be compared within the results shown in FIG. 8-9 to determine a recommended course of treatment.

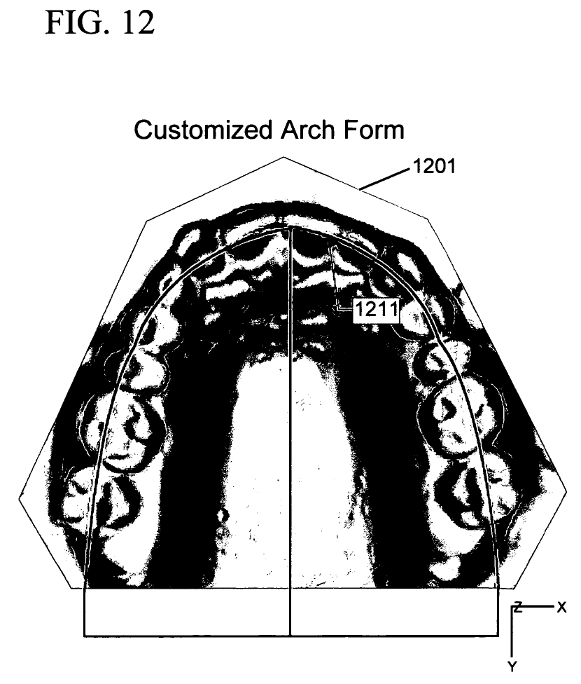

FIG. 12 illustrates an electronic model of an upper dental arch having a customized arch form constructed according to an embodiment of the present invention. The arch 1211 is shown as part of the electronic model 1201 for an upper impression of the teeth. This arch 1211 is used as part of the orthodontic treatment plan as the teeth are moved to be located along the arch. The construction of an idealized arch obtainable for a patient is valuable in the development of a treatment plan and may be performed using the electronic model before any treatment begins on a patient. The arch and treatment plan may be constructed using the original electronic model of FIG. 6. Alternatively, the arch may also be constructed using the electronic models shown in FIGS. 6 and 8 to permit the comparison of the results obtained using each course of treatment.

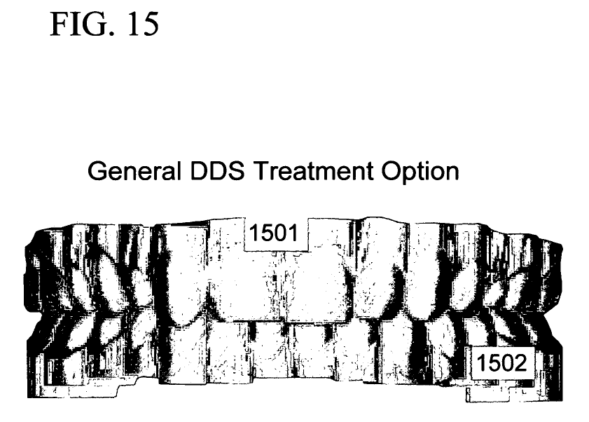

FIG. 15 illustrates an electronic model of upper 1501 and lower 1502 arches for a general dentist treatment plan constructed according to an embodiment of the present invention. In this option, typically tooth restoration and reconstruction is performed with the creation and use of crowns, bridges and implants. General dentist treatment may be in addition to or instead of the treatment plans proposed by other dental professionals. In this particular case, a replacement tooth is created to fill the space identified in FIGS. 9 and 11 above. Tooth creation may be performed using a library of tooth crown designs, may be performed by manually sculpting a tooth from a properly sized block of space, may be performed by tooth mirroring in which an existing tooth from the patient is used as a basis for designing a replacement tooth, and may be performed using a parametric model for teeth that is scaled to fit the available space. All of these methods result in the creation of a replacement tooth that may be fabricated as an implant or crown that is inserted into the patient's mouth. For additional details regarding how this tooth creation process is performed, see U.S. patent application Ser. No. 10/429,288.

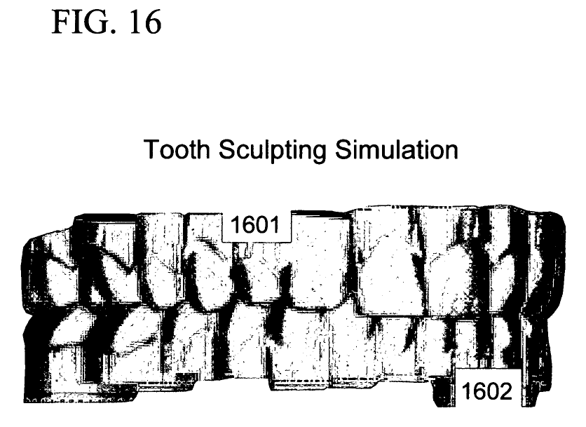

FIG. 16 illustrates an electronic model of upper 1601 and lower 1602 arches of a patient's teeth having tooth sculpting according to an embodiment of the present invention. As discussed above, teeth needed restoration may utilize components that may be specified using sculpting techniques. Currently, dental professionals may manually sculpt wax and similar substances to create a physical model for the appliance to be installed in a patient. The process of shaping the appliance is similar to sculpting and has been used for significant period of time. Electronic models permit this sculpting to occur digitally where a dental professional modifies the external surface of a tooth or appliance to create the definition for the desired tooth surface. Once the desired shape is defined, the appliance, retainer or crown may be fabricated. For additional details regarding how this tooth creation process is performed, see U.S. patent application Ser. No. 10/429,288.

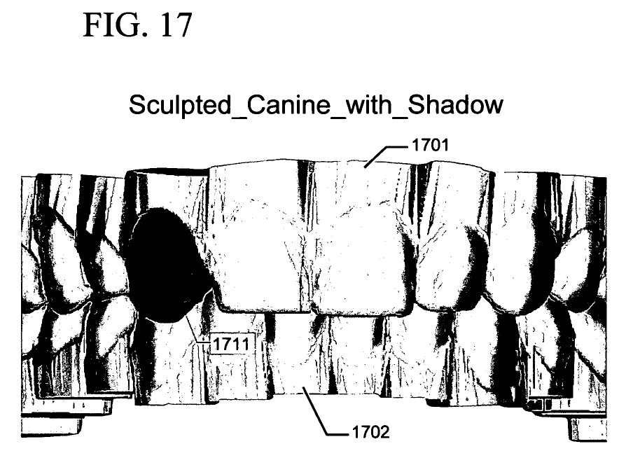

FIG. 17 illustrates an electronic model of a patient's teeth having a canine tooth sculpted according to an embodiment of the present invention. In this figure, the tooth 1711 being shaped is highlighted and its outer surface is moved to create a desired surface. This sculpting is performed on the electronic model for the teeth 1701 and may be positioned to illustrate its proximity and interaction with adjacent and opposing teeth on the lower arch model 1702. Additional information regarding the measurement and display of the interaction of adjacent and opposing teeth may be found in U.S. patent application Ser. No. 10/426,252.

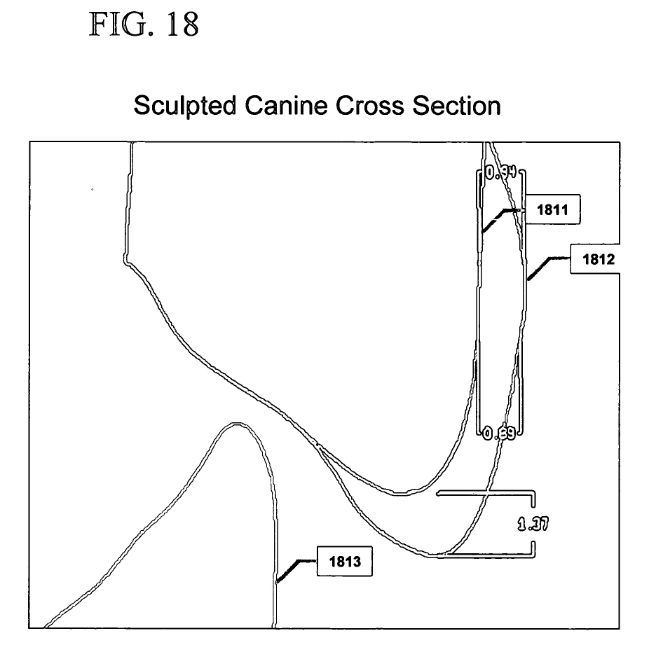

FIG. 18 illustrates a cross-section view from an electronic model of an patient's teeth having a canine tooth sculpted according to an embodiment of the present invention. Once a sculpted tooth has been created, various views of the tooth, both in its existing condition 1811 and its proposed condition 1812 may be presented. In this cross-section view, the before and after shape of the sculpted tooth 1811-1812 are shown in relation to the opposing tooth 1813. From all of this information, a dental professional may determine whether the proposed course of treatment produces a desired result using the electronic models prior to the initiation of any treatment on a patient. This analysis may also be updated at various points along a treatment plan to ensure that the course of treatment will ultimately obtain the desired results.

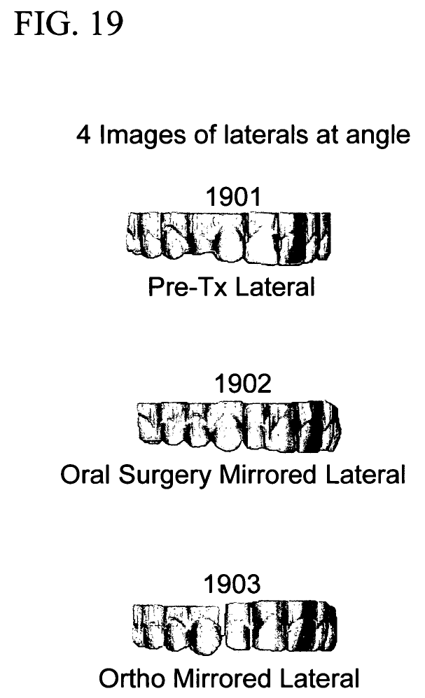

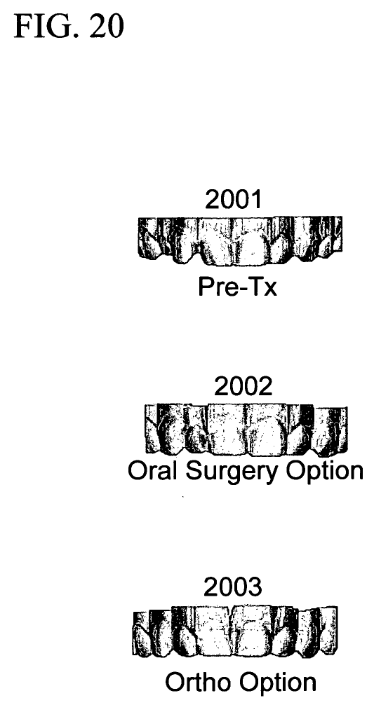

FIG. 19 illustrates a set of electronic models 1901-1903 of a patient's teeth for various treatment options according to an embodiment of the present invention. FIG. 20 illustrates another set of electronic models 2001-2003 of a patient's teeth for various treatment options according to an embodiment of the present invention. These two figures permit one or more dental professionals to perform side-by-side comparisons of treatment plans and/or various steps in a treatment plan to determine if a desired result is obtainable, and if so at what cost. All of this information may be shared with the other dental professionals who may be part of the treatment options for input and recommendations. The patient may be provided with some or all of the information to provide information, education and encouragement while creating realistic expectations for the results obtainable and the amount of effort and treatment required to obtain a result. Finally, information maybe provided to other professionals who have a financial interest in a selected treatment option to provide any guidance that may be needed as well.

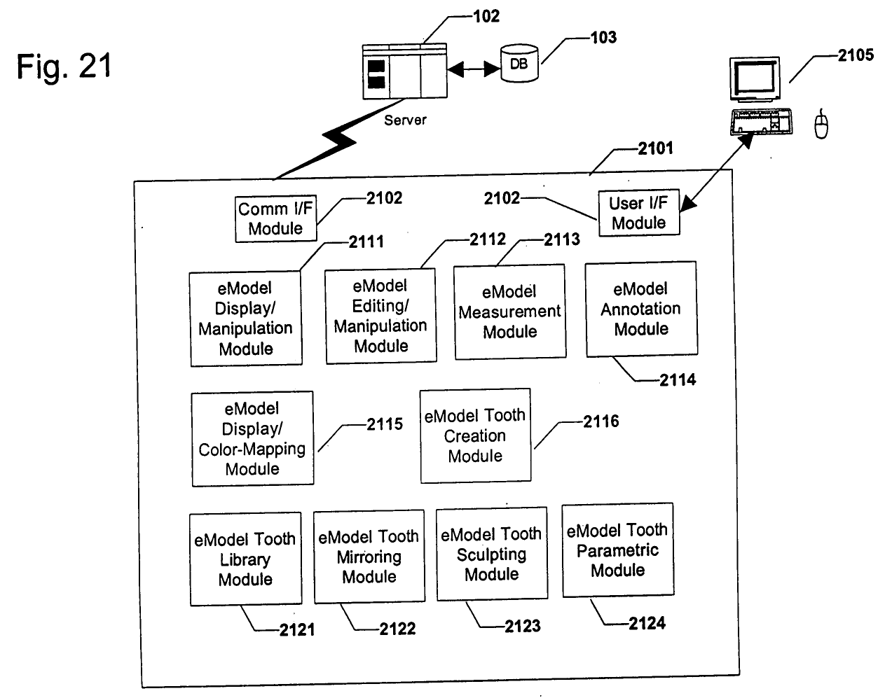

FIG. 21 illustrates a set of processing modules comprising a client computing system for dentists, oral surgeons, and other health care providers according to an embodiment of the present invention. The client processing system 2101 consists of a set of processing modules used to view, edit, manipulate, measure, annotate and sculpt an electronic model. The fill set of processing modules is typically utilized by dental professionals while creating and using an electronic model as part of specifying and reviewing treatment plans. The processing modules 2101 communicate with a central server 102 and its associated database 103 of electronic models using a communications interface module 2102. The dental professional interacts with the system using input and display devices 2105 that interact with the system through a user interface module 2102. To interact with the electronic models, the system includes an eModel display/manipulation module 2111, an eModel editing/manipulation module 2112, an eModel measurement module 2113, an eModel annotation module 2114, an eModel display/color-mapping module 2115, and an eModel tooth creation module 2116. The eModel tooth creation module 2116 interacts with a set of modules including an eModel tooth library module 2121, an eModel tooth mirroring module 2122, an eModel tooth sculpting module 2123, and an eModel tooth parametric module 2124.

The eModel display/manipulation module 2111 permits the user to move the electronic model in all directions as well as move the upper and lower arch models relative to each other. As such, articulation and interaction of the opposing teeth are possible. The eModel editing/manipulation module 2112 permits the user to identify individual teeth within the electronic module as well as separate and move the individual teeth relative to each other as part of a treatment plan. The eModel measurement module 2113 permits a user to obtain spatial measurements for any two points on the surface of an electronic model. The eModel annotation module 2114 permits users to add notes and annotations to the electronic module for view by others. The eModel display/color-mapping module 2115 illustrates the proximity of adjacent and opposing teeth to a portion of a surface of an electronic model as the various model surfaces are moved relative to each other. Finally, the eModel tooth creation module 2116 permits the creation and modification of individual tooth surfaces that may then be manufactured into appliances and other components that are installed. The eModel tooth library module 2121 permits the creation of new teeth from a library of generic teeth. The eModel tooth mirroring module 2122 permits the creation of new teeth from a mirrored copy of an existing tooth in the electronic model. The eModel tooth sculpting module 2123 permits the creation of new teeth from an arbitrary tooth surface. The eModel tooth parametric module 2124 permits the creation of new teeth parametrically from a library of generic teeth.

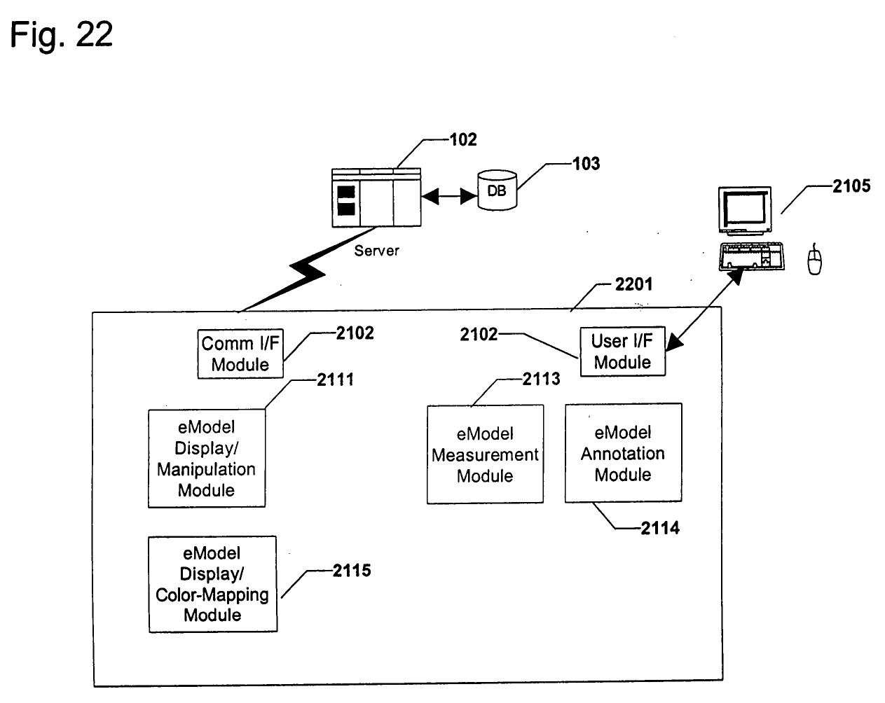

FIG. 22 illustrates a set of processing modules comprising a client computing system for patients and insurance payment personnel according to an embodiment of the present invention. This client processing system 2201 comprises a subset of the module described in FIG. 21 as these classes of users are typically expected to only view electronic models rather than manipulate and edit them. As with any module construction of software, any particular client may be given access to any subset of available processing modules as might be needed to provide a desired level of functionality. For example, an insurance professional may need to add annotations to a communication with a dental professional while a patient would typically would not do so. In all cases, these processing modules are explained in more detail within the above referenced patent applications that provide additional descriptions for implementations of the functionality provided to users.

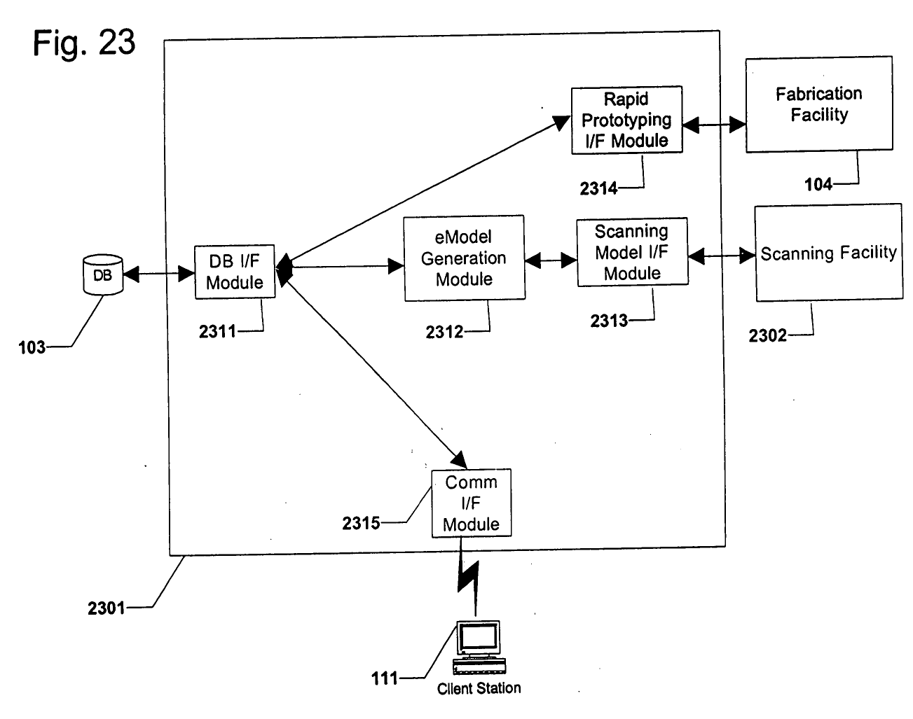

FIG. 23 illustrates a set of processing modules comprising a server computing system according to an embodiment of the present invention. A server processing system 2301 includes a communications interface module 2315 to perform its communications with remote clients over the implemented communications channel. The server processing system 2301 also includes a database interface module 2311 to place electronic models generated in the server and received from dental professionals into the database 103. This module 2311 may implement a versioning system to identify the variations for a particular patient's various electronic models in the database 103.

The server processing system 2301 also includes a rapid prototyping interface module 2314 to provide the STL files needed by fabrication facilities 104 to manufacture various appliances and components. The server processing system 2301 includes a scanning interface module 2313 to receive scanned impression data, in the form of raw scanned input data from a scanning facility 2302, that is used to generate polygonal mesh-based electronic models. The server processing system 2301 uses an eModel generation module 2312 to process the raw scanned input data into the polygonal mesh-based electronic models. Once again, additional details regarding the scanning, electronic model generation and rapid prototyping processes may be found within the above referenced patent applications that provide additional descriptions for implementations of the functionality provided to users.

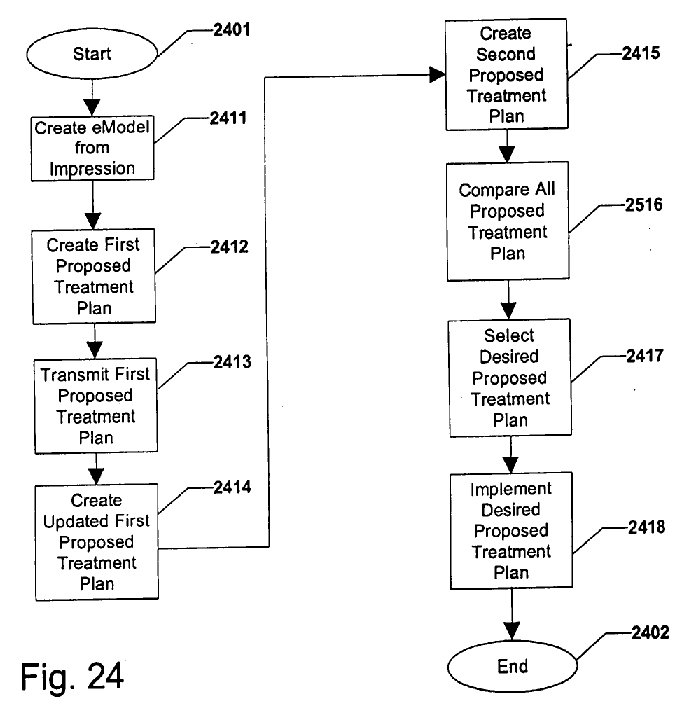

FIG. 24 illustrates a flowchart for a process of creating a treatment plan for a patient using multiple dental health care providers according an embodiment of the present invention. The processing begins 2401 when an electronic model is generated from scanned data obtained from an impression within module 2411. A dental professional uses the electronic model to create a first proposed treatment plan in module 2412. The first proposed treatment plan is transmitted to a second dental professional in module 2413.

The second dental professional creates an updated first proposed dental treatment plan in module 2414. The second dental professional also creates a second proposed dental treatment plan in module 2415. All of the proposed treatment plans are compared by the dental professionals and presented to the patient in module 2516. A desired treatment plan is selected in module 2417 where the appropriate dental professional implements the selected treatment plan in module 2418 before the processing ends 2402.

While some of the above described embodiments of the present invention describe a system and method for constructing dental crowns, bridges and implants using a lost-wax process, one skilled in the art will recognize that other methods of manufacture of the dental devices are possible. The present invention allows fabrication of fixed and removable prosthodontic prosthesis such as copings, crowns, inlays, onlays, veneers, bridges, frameworks, implants, abutments, surgical stents, full or partial dentures and other hybrid fixed prosthesis for dental applications. One skilled in the art will easily recognize that other CBI and orthodontic appliances may readily be constructed in accordance of the present invention. As such, as long as the manufacturing process utilizes electronic models for impressions of patient's teeth and corresponding electronic models for the crown devices, the present invention would be useable in other manufacturing methodologies. It is to be understood that other embodiments may be utilized and operational changes may be made without departing from the scope of the present invention.

The foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Thus the present invention is presently embodied as a method, apparatus, computer storage medium or propagated signal containing a computer program for providing a method, apparatus, and article of manufacture for utilizing electronic models of patient teeth in interdisciplinary dental treatment plans.

1. A method of utilizing a stored electronic model of at least a portion of a patient's teeth, comprising:
a) accessing the stored electronic model, wherein accessing comprises separate access by each entity in one or more of the following groups of entities:
i) two or more health care providers from interdisciplinary dental fields;
ii) at least one dental health care provider and a dental insurance provider;
iii) at least one dental health care provider and the patient; and
b) each entity separately displaying the electronic model.

2. The method of claim 1, further comprising modifying the electronic model, and storing the modified electronic model.

3. The method of claim 1, further comprising adding an annotation to the electronic model, and saving the annotated electronic model.

4. The method of claim 2, wherein the access is by two or more health care providers from interdisciplinary dental fields, and further comprising sharing the modified electronic model between the health care providers.

5. The method of claim 2, further comprising constructing a dental device based on the modified electronic model.

6. A method of providing access to a stored electronic model of at least a portion of a patient's teeth, comprising:
a) providing a storage device that stores the electronic model;
b) providing an access interface between the storage device and at least two separate locations through which users at the at least two separate locations can access the electronic model stored in the storage device;
c) permitting the users at the two separate locations to access the electronic model on the storage device.

7. The method of claim 6, further comprising permitting the users to save a modified version of the electronic model on the storage device.

8. A method of developing a dental treatment plan for a patient using a stored electronic model of at least a portion of a patient's teeth, comprising:
a) a first dental health care provider:
i) accessing and displaying the electronic model; and
ii) using the electronic model to create a first proposed treatment plan; and
b) a second dental health care provider:
i) accessing and displaying the electronic model; and
ii) using the electronic model to create a second proposed treatment plan.

9. The method of claim 8, further comprising at least the first dental health care provider modifying the electronic model and storing the modified electronic model.

10. The method of claim 8, further comprising at least one additional dental health care provider:
i) accessing and displaying the electronic model; and
ii) using the electronic model to create a third proposed treatment plan.

11. The method of claim 9, further comprising at least the second dental health care provider accessing the stored modified electronic model and displaying the stored modified electronic model.

12. The method of claim 8, further comprising at least one dental insurance provider accessing and displaying the electronic model.

13. The method of claim 8, further comprising the patient accessing and displaying the electronic model.

14. The method of claim 8, wherein the first dental health care provider comprises an orthodontist, and the first proposed treatment plan comprises an orthodontic treatment plan.

15. The method of claim 8, wherein the first dental health care provider comprises an oral surgeon, and the first proposed treatment plan comprises an oral surgery treatment plan.

16. The method of claim 8, wherein the first dental health care provider comprises a general dentist, and the first proposed treatment plan comprises a general dentistry treatment plan.

17. The method of claim 8, further comprising adding an annotation to the electronic model, and saving the annotated electronic model.

18. A method of developing a dental treatment plan for a patient using a stored electronic model of at least a portion of a patient's teeth, comprising:
a first dental health care provider accessing and displaying the stored electronic model; and
the first dental health care provider electronically transmitting the electronic model to a second dental health care provider.

19. The method of claim 18, further comprising the first dental health care provider modifying the electronic model, storing the modified electronic model, and transmitting the modified electronic model to the second dental health care provider.

20. The method of claim 18, further comprising the second dental health care provider modifying the transmitted electronic model.

21. The method of claim 18, further comprising the first dental health care provider adding an annotation to the electronic model, saving the annotated electronic model, and transmitting the annotated electronic model to the second dental health care provider.

22. The method of claim 18, further comprising the second dental health care provider adding an annotation to the transmitted electronic model.

23. A system for providing access to a stored electronic model of at least a portion of a patient's teeth, comprising:
a) a storage device that stores the electronic model;
b) an access interface between the storage device and at least two separate locations through which users at the at least two separate locations can access the electronic model stored in the storage device;
c) a computing system at each of the two separate locations, each computing system includes a processing system, an input and display device, and an interface module that is configured to interface with the access interface.

24. The system of claim 23, wherein the processing system at one of the locations comprises a set of processing modules that are configured for use by dental health care providers.

25. The system of claim 24, wherein the processing modules include two or more of the following: a display/manipulation module, an editing/manipulation module, a tooth measurement model, an annotation module, a display/color-mapping module, a tooth creation module, a tooth library module, a tooth mirroring module, a tooth sculpting module, and a tooth parametric module.

26. The system of claim 23, wherein the processing system at one of the locations comprises a set of processing modules that are configured for use by patients and/or dental insurance providers.

27. The system of claim 26, wherein the processing modules include two or more of the following: a display/manipulation module, a display/color-mapping module, tooth measurement model, and an annotation module.

28. The system of claim 23, wherein the processing system at one of the locations comprises a set of modules that are configured for use in fabricating a dental device based on the electronic model.

29. The system of claim 23, wherein one computing system is located at an orthodontists office.

30. The system of claim 23, wherein one computing system is located at an oral surgeons office.

31. The system of claim 23, wherein one computing system is located at a general dentists office.

32. The system of claim 23, wherein one computing system is located at a health care providers office.

33. The system of claim 23, wherein one computing system is located at a dental insurers office.

34. The system of claim 23, wherein one computing system is located at a patients office or home.
